(19) United States
(12) Patent Application Publication
(10) Pub. No.: US 2006/0129732 A1
(43) Pub. Date: Jun. 15, 2006

(54) Multi-socket circuit board chip bridging device

(76) Inventors: Sheng-Yuan Tsai, Taipei (TW); Chi-Wei Yang, Taipei (TW)

Correspondence Address: PEARL COHEN ZEDEK, LLP, 1500 BROADWAY 12TH FLOOR, NEW YORK, NY, 10036, US

(21) Appl. No.: 11/011,132

(22) Filed: Dec. 15, 2004

(51) Int. Cl. G06F 13/14

(52) U.S. Cl. 710/305

(57) ABSTRACT

A multi-socket circuit board chip bridging device is proposed, which is designed for use in conjunction with a multi-socket circuit board having multiple sockets and utilizing a special type of bus architecture, such as the HT (HyperTransport) bus architecture, for use to be mounted on a selected one of the sockets for the purpose of connecting one chip mounted on a first socket to another chip mounted on a second socket on the multi-socket circuit board. This feature allows manufacturer to utilize just one kind of circuit board for the implementation of a variety of multi-processor computer motherboards or hardware platforms having different number of processors, without having to design different types of multi-processor computer motherboards, thus representing a more cost-effective solution to the manufacture of multi-processor computer motherboards than prior art.

### FIELD OF THE INVENTION

This invention relates to computer hardware technology, and more particularly, to a multi-socket circuit board chip bridging device which is designed for use in conjunction with a multi-socket circuit board having multiple sockets and utilizing a special type of bus architecture, such as the HT (HyperTransport) bus architecture, for use to be mounted on a selected one of sockets for the purpose of connecting one chip, such as an AMD (Advanced Micro Devices) microprocessor chip, mounted on a first socket to another chip, such as another AMD microprocessor chip or an I/O port module chip, mounted on a second socket on the multi-socket circuit board.

### BACKGROUND OF THE INVENTION

In computer engineering, data processing speed can be increased by utilizing parallel processing technology which employs two or more processors on a single motherboard. With parallel processing, data can be concurrently processed by two or more processors at the same time, so that the overall processing speed from multi-processor systems is significantly higher than conventional uni-processor systems.

In the manufacture of multi-processor computer motherboards, since the market demands different number of processors on the motherboard, the manufacturer often needs to design varieties of multi-processor computer motherboards for different parallel processing requirements, which may include dual-processor motherboard, triple-processor motherboard, quad-processor motherboard, and so on. In other words, the manufacturer needs to design one kind of circuit board to implement dual-processor systems, another kind of circuit board to implement triple-processor systems, and still another kind of circuit board to implement quad-processor systems, and so forth. One apparent drawback to this practice is that it would significantly increase manufacture cost.

The computer industry therefore needs a new technology that allows the manufacturer to utilize just one kind of circuit board for the implementation of a variety of multi-processor computer motherboards having different number of processors.

### SUMMARY OF THE INVENTION

It is therefore an objective of this invention to provide a multi-socket circuit board chip bridging device which can be utilized for the implementation of a variety of multi-processor computer motherboards or hardware platforms having different number of processors.

It is another objective of this invention to provide a multi-socket circuit board chip bridging device which represents a cost-effective solution to the manufacture of multi-processor computer motherboard

The multi-socket circuit board chip bridging device according to the invention is designed for use in conjunction with a multi-socket circuit board having multiple sockets and utilizing a special type of bus architecture, such as the HT (HyperTransport) bus architecture, for use to be mounted on a selected one of sockets for the purpose of connecting one chip, such as an AMD (Advanced Micro Devices) microprocessor chip, mounted on a first socket to another chip, such as another AMD microprocessor chip or an I/O port module chip, mounted on a second socket on the multi-socket circuit board.

The multi-socket circuit board chip bridging device according to the invention is advantageous to use in that it allows manufacturer to utilize just one kind of circuit board for the implementation of a variety of multi-processor computer motherboards having different number of processors, without having to design different types of multi-processor computer motherboards. The invention thus represents a cost-effective solution to the manufacture of multi-processor computer motherboards.

### BRIEF DESCRIPTION OF DRAWINGS

The invention can be more fully understood by reading the following detailed description of the preferred embodiments, with reference made to the accompanying drawings, wherein:

FIG. 1A is a schematic diagram showing an example of the application of the multi-socket circuit board chip bridging device according to the invention with a multi-socket circuit board;

FIG. 1B is a schematic diagram used to depict the utilization of the multi-socket circuit board shown in FIG. 1A to implement a dual-processor computer motherboard;

FIG. 2A is a schematic diagram showing a plan view of a first preferred embodiment of the multi-socket circuit board chip bridging device according to the invention;

FIG. 2B is a schematic diagram showing a plan view of a second preferred embodiment of the multi-socket circuit board chip bridging device according to the invention;

FIG. 3 is a schematic diagram used to depict an example of the utilization of the multi-socket circuit board chip bridging device of the invention with a 6-socket circuit board to implement a triple-processor computer motherboard; and

FIG. 4 is a schematic diagram showing a dual-processor system implemented with the multi-socket circuit board chip bridging device according to the invention.

### DETAILED DESCRIPTION OF PREFERRED EMBODIMENTS

The multi-socket circuit board chip bridging device according to the invention is disclosed in full details by way of preferred embodiments in the following with reference to the accompanying drawings.

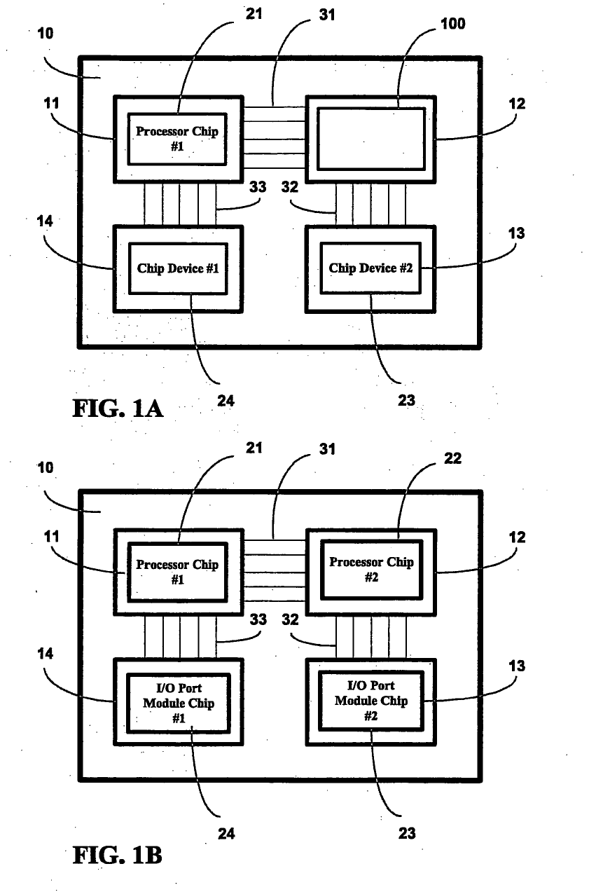

FIG. 1A is a schematic diagram showing an example of the application of the multi-socket circuit board chip bridging device of the invention 100 with a multi-socket circuit board 10 (a 4-socket circuit board in the example of FIG. 1A). As shown, the multi-socket circuit board 10 includes a plurality of sockets, including a first socket 11, a second socket 12, a third socket 13, and a fourth socket 14 (note that in this embodiment, only 4 sockets are used for demonstrative purpose, but in practice, the number of sockets is unrestricted), which are interconnected by signal buses 31, 32, 33 that are compliant with the HT (HyperTransport) or similar bus architecture.

In practice, it is assumed that the first socket 11 is mounted with a microprocessor chip 21, such as an AMD (Advanced Micro Devices) microprocessor whose I/O utilizes the HT bus architecture, and the third socket 13 and the fourth socket 14 are respectively mounted with chip device 23, 24 that operate in conjunction with the microprocessor chip 21. In this case, the multi-socket circuit board chip bridging device of the invention 100 can be mounted on the second socket 12 for connecting the microprocessor chip 21 mounted on the first socket 11 by way of the second socket 12 to the chip device 23 mounted on the third socket 13 so as to allow the microprocessor chip 21 to communicate via the multi-socket circuit board chip bridging device of the invention 100 with the chip device 23.

As shown in FIG. 1A, if the first socket 11 is mounted with a microprocessor chip 21 while the second socket 12 is mounted with the multi-socket circuit board chip bridging device of the invention 100, it can be used to implement a uni-processor computer motherboard. On the other hand, as shown in FIG. 1B, if the multi-socket circuit board chip bridging device of the invention 100 is removed from the second socket 12 and instead a second processor chip 22 is mounted on the second socket 12, it can be used to implement a dual-processor computer motherboard. In practical implementation, it is required that all of the chip devices 21, 22, 23, 24 support the HT (HyperTransport) bus architecture.

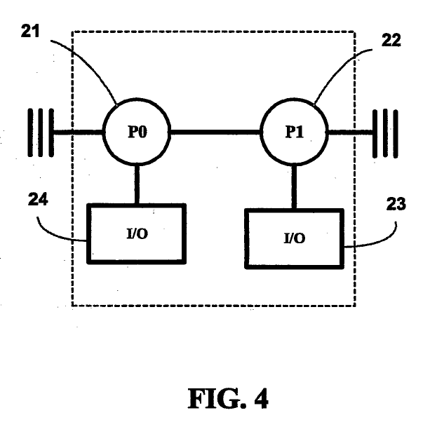

In addition, if two 1/0 port module chips 23, 24 are respectively mounted on the third socket 13 and the fourth socket 14 as shown in FIG. 1B, it can be used to implement a dual-processor system shown in FIG. 4.

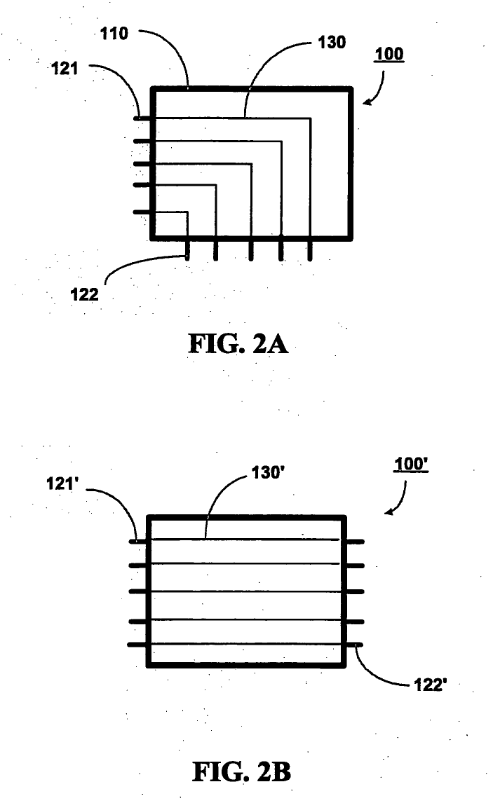

FIG. 2A is a schematic diagram showing a plan view of a first preferred embodiment of the multi-socket circuit board chip bridging device of the invention 100, which comprises: (a) a housing member 110; (b) a first set of electrical connecting points 121; (c) a second set of electrical connecting points 122; and (d) a group of electrically-conductive lines 130. FIG. 2B shows a second preferred embodiment of the multi-socket circuit board chip bridging device of the invention (here labeled with the reference numeral 100′).

The housing member 110 is for example is rectangular body of printed circuit whose size is dimensioned to be fittable to the third socket 13. In practice, the housing member 110 can be formed in a shape similar to the encapsulation body of an IC chip for easy handling.

The first set of electrical connecting points 121 are arranged on a first side of the housing member 110 and implemented as pins or solder balls (i.e., similar to the electrical contacts on most chip devices). For use with the multi-socket circuit board 10 shown in FIG. 1A, each of the electrical connecting points 121 corresponds to each line in the HT bus 31 between the socket 12 and the first socket 11, for use to be connected to the HT bus 31 when the multi-socket circuit board chip bridging device of the invention 100 is mounted on the socket 12 (note that in the example of FIG. 2A, only 5 electrical connecting points 121 are shown for demonstrative purpose, but in practice, the number of the electrical connecting points 121 is unrestricted, and can be more than hundred).

The second set of electrical connecting points 122 are arranged on a second side of the housing member 110 (either on the adjacent side as shown in FIG. 2A, or on the opposite side as shown in FIG. 2B) and implemented as pins or solder balls. For use with the multi-socket circuit board 10 shown in FIG. 1A, each of the electrical connecting points 122 corresponds to each line in the HT bus 32 between the socket 12 and the third socket 13, for use to be connected to the HT bus 32 when the multi-socket circuit board chip bridging device is mounted on the socket 12.

The electrically-conductive lines 130 are arranged inside the housing member 110 for electrically interconnecting the first set of electrical connecting points 121 with the second set of electrical connecting points 122. These electrically-conductive lines 130 can be realized either as bent lines to connect the first set of electrical connecting points 121 on one side to the second set of electrical connecting points 122 on the adjacent side as illustrated in FIG. 2A, or as straight lines to connect the first set of electrical connecting points 121′ on one side to the second set of electrical connecting points 122′ on the opposite side as illustrated in FIG. 2B (note that in the example of FIG. 2A, only 5 electrically conductive lines 130 are shown for demonstrative purpose, but in practice, the number of the electrically conductive lines 130 is unrestricted and can be more than hundred, and which can be implemented with a multi-layer layout structure to accommodate these electrically conductive lines 130 within the housing member 110).

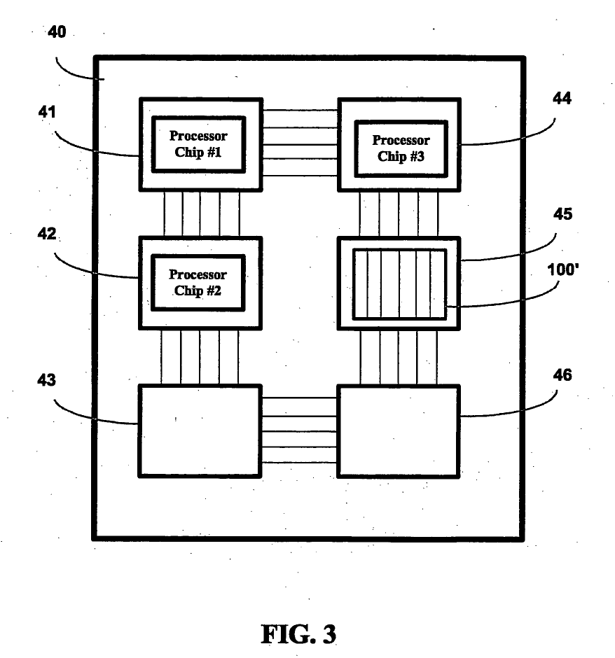

FIG. 3 shows another example of the application of the invention with a multi-socket circuit board 40 (a 6-socket circuit board) having 6 sockets 41, 42, 43, 44, 45, 46. It is assumed that a manufacturer wants to utilize this multi-socket circuit board 40 to implement a triple-processor computer motherboard, then the manufacturer can simply mount three processor chips respectively on the socket 41, 42, and 44, and mount the second preferred embodiment of the multi-socket circuit board chip bridging device of the invention 100′ shown in FIG. 2B on the socket 45.

In conclusion, the invention provides a multi-socket circuit board chip bridging device for use with a multi-socket circuit board having multiple sockets and utilizing a special type of bus architecture, such as the HT (HyperTransport) bus architecture, for use to be mounted on a selected one of sockets for the purpose of connecting one chip mounted on a first socket to another chip mounted on a second socket on the multi-socket circuit board. The multi-socket circuit board chip bridging device according to the invention is advantageous to use in that it allows manufacturer to utilize just one kind of circuit board for the implementation of a variety of multi-processor computer motherboards having different number of processors, without having to design different types of multi-processor computer motherboards. The invention thus represents a more cost-effective solution to the manufacture of multi-processor computer motherboard than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A multi-socket circuit board chip bridging device for use with a multi-socket circuit board having a plurality of sockets including at least a first socket, a second socket, and a third socket which are interconnected by a special type of bus architecture, and wherein the first socket is mounted with a first chip device and the second socket is mounted with a second chip device, for use to be mounted on the third socket for connecting the first chip device mounted on the first socket by way of the third socket to the second chip device mounted on the second socket;
the multi-socket circuit board chip bridging device comprising:
a housing member;
a first set of electrical connecting points, which are arranged on a first side of the housing member, and each of which corresponds to each bus line between the third socket and the first socket, for use to be connected to the bus between the third socket and the first socket when the multi-socket circuit board chip bridging device is mounted on the third socket;
a second set of electrical connecting points, which are arranged on a second side of the housing member, and each of which corresponds to each bus line between the third socket and the second socket, for use to be connected to the bus between the third socket and the second socket when the multi-socket circuit board chip bridging device is mounted on the third socket; and
a group of electrically-conductive lines, which are arranged inside the housing member, for electrically interconnecting the first set of electrical connecting points with the second set of electrical connecting points.

2. The multi-socket circuit board chip bridging device of claim 1, wherein the multi-socket circuit board is a uni-processor computer motherboard.

3. The multi-socket circuit board chip bridging device of claim 1, wherein the multi-socket circuit board is a multi-processor computer motherboard.

4. The multi-socket circuit board chip bridging device of claim 1, wherein the bus architecture is an HT (HyperTransport) compliant bus architecture.

5. The multi-socket circuit board chip bridging device of claim 1, wherein the first set of electrical connecting points and the second set of electrical connecting points are implemented as pins.

6. The multi-socket circuit board chip bridging device of claim 1, wherein the first set of electrical connecting points and the second set of electrical connecting points are implemented as solder balls.
